(19) United States
(12) Patent Application Publication
(10) Pub. No.: US 2025/0112461 A1
(43) Pub. Date: Apr. 3, 2025

(54) DYNAMIC SELECTION OF POWER ROUTES IN CIRCUITS

(71) Applicant: Arm Limited, Cambridge (GB)

(72) Inventor: Alexander Klimov, Hadera (IL)

(73) Assignee: Arm Limited, Cambridge (GB)

(21) Appl. No.: 18/640,206

(22) Filed: Apr. 19, 2024

(30) Foreign Application Priority Data
Oct. 2, 2023 (IL) 307420

(51) Int. Cl. H02J 3/00; G06F 21/72

(52) U.S. Cl. CPC H02J 3/001; G06F 21/72

(57) ABSTRACT

An apparatus is provided for varying paths from power sources to components in order to inhibit side channel attacks. The power source provides power. The circuit component consumes the power to perform a function and a power grid provides a plurality of redundant paths by which the power can flow from between the circuit component and one of a power source and ground, to perform the function. The power grid is dynamically selects at least one active path of the redundant paths through which the power flows to perform the function.

### CROSS-REFERENCE TO RELATED APPLICATION

This application claims the benefit of the Israel patent application No. 307420 filed on Oct. 2, 2023, the disclosure of which is incorporated herein by reference in its entirety.

### TECHNICAL FIELD

The present disclosure relates to circuits, as may be used in a data processing apparatus.

### DESCRIPTION

A side-channel attack (SCA) is used to extract secrets processed by a circuit by using side channels, such as the power consumed by an apparatus (e.g., a chip) or the electromagnetic field generated during the processing.

### SUMMARY

Viewed from a first example configuration, there is provided an apparatus comprising: a circuit component configured to consume power to perform a function; and a power grid configured to provide a plurality of redundant paths by which the power can flow between the circuit component and one of the power source and ground, to perform the function, wherein the power grid is configured to dynamically select at least one active path of the redundant paths through which the power flows between the circuit component and the one of the power source and ground, to perform the function.

Viewed from a second example configuration, there is provided a method comprising: consuming power at a circuit component to perform a function; providing a power grid configured to provide a plurality of redundant paths by which the power can flow between the circuit component and one of a power source and ground, to perform the function, wherein the power grid is configured to dynamically select at least one active path of the redundant paths through which the power flows between the circuit component and the one of the power source and ground, to perform the function.

Viewed from a third example configuration, there is provided a non-transitory computer-readable medium to store computer-readable code for fabrication of an apparatus comprising: a circuit component configured to consume power to perform a function; and a power grid configured to provide a plurality of redundant paths by which the power can flow between the circuit component and one of a power source and ground, to perform the function, wherein the power grid is configured to dynamically select at least one active path of the redundant paths through which the power flows between the circuit component and the one of the power source and ground, to perform the function.

### BRIEF DESCRIPTION OF THE DRAWINGS

The present invention will be described further, by way of example only, with reference to embodiments thereof as illustrated in the accompanying drawings, in which:

FIG. 1A illustrates an example circuit diagram showing a transistor in the form of an n-type transistor;

FIG. 1B shows how such a transistor might be implemented in a circuit;

FIG. 2 illustrates how the path(s) to a component (in this case taking the form of a cryptography unit) from a power source can be changed;

FIG. 3A shows another example in which on/off switches can be used to change a number and length of paths between the power source and component;

FIG. 3B illustrates a variant in which the switches are still dual state, but in which the switch is connected to a first wire and the states are for the switch to also be connected to a second wire or also to be connected to a third wire;

FIG. 4 shows an example in which a fail-safe path has been added to the electrical component;

FIG. 5 shows an example in which there are multiple power sources;

FIG. 6A shows, in the form of a flowchart, a first method for configuring the power grid;

FIG. 6B shows, in the form of another flowchart, another method for selecting an active path; and

FIG. 7 shows a packaged chip implementation.

### DESCRIPTION OF EXAMPLE EMBODIMENTS

Before discussing the embodiments with reference to the accompanying figures, the following description of embodiments is provided.

In accordance with one example configuration there is provided an apparatus comprising: a power source configured to provide power; a circuit component configured to consume power to perform a function; and a power grid configured to provide a plurality of redundant paths by which the power can flow between the circuit component and one of the power source and ground, to perform the function, wherein the power grid is configured to dynamically select at least one active path of the redundant paths through which the power flows between the circuit component and the one of the power source and ground, to perform the function.

It is possible to determine secret data in a circuit by, for instance, analysis of the electromagnetic fields that are produced. This technique works through, for instance, probabilistic analysis. The above examples makes it possible to camouflage the electromagnetic field generated in the circuit as a current flows (either from the source to the component or from the component to ground). This is achieved by providing a number of redundant paths in which the power can flow. The number and length of such paths change the resistance experienced by the current in flowing from the power source to the component. This in turn causes electromagnetic fields to be generated in different locations (and possibly of different strengths). This therefore makes it more difficult to achieve a probabilistic analysis. The dynamic selection of the path also makes it possible to camouflage the impedance, which is another physical characteristic whose probing can be used to infer secret information (see, e.g., LeakyOhm: Secret Bits Extraction using Impedance Analysis by Saleh Mhalaj Monfared and Tahoura Mosavirik). In particular, as noted in the LeakyOhm paper, the data stored in registers alters their impedance. By probing the impedance, it may be possible to probabilistically infer the contents of those registers. However, by dynamically changing the path through which current flows to a component (such as a register), it is possible to vary the impedance, which again makes it harder to probabilistically infer the contents of the register. The present technique also allows the power consumed to be camouflaged. The present technique also allows for randomization of glitches. Glitches occur due to data being provided at different times within a clock cycle. Consider the example of an XOR gate that takes two inputs A and B and produces the result A XOR B. If A and B start as the value 1 then then result will be 0. During a clock cycle, A and B both might change to 0 and the result will still be 0. However, it is unlikely that both A and B will change from 1 to 0 at the same instant. For a small fraction of the clock cycle, one of A and B will be 1 and the other will be 0. As a result, the XOR gate (which will produce the result almost instantaneously) will output 1. In practice, the propagation of this temporary glitch is limited so that only the value being output at the tick of a clock cycle is propagated. Nevertheless, glitches can give away the contents of data (again through probabilistic analysis) and by randomizing glitches, it is possible to make such a side channel attack much harder. In any event, regardless of the path(s) that is/are selected, the function performed by the component remains the same. That is, the functionality itself does not change when one path is taken rather than another path being taken. Although the above examples consider logic gates and transistors, it is not essential that the component be either a transistor or a logic gate. Indeed, the component could be an array of such devices or could be a device that has no such devices at all.

In some examples, the power grid is configured to dynamically select the at least one active path at runtime. It is therefore possible to change the path(s) selected for the power to flow from a power source to a component while the system is running (e.g., in response to an instruction or after a period of time has elapsed or based on a condition). In other examples, the at least one active path may be selected when the system starts up. Although this may produce fewer changes that might be possible when changes can occur at runtime, it still makes it difficult for any standard attack vector to be devised since the system will change each time it activates.

In some examples, the power grid is configured to dynamically select the at least one active path with a predetermined frequency. The active path(s) can therefore be continually changed. The frequency may be counted by natural time or could be in response to the occurrence of a certain number of events (e.g., clock cycles).

In some examples, the power grid is configured to provide the plurality of redundant paths simultaneously. That is, there may be a plurality of redundant paths that are available. In other embodiments, there may be a plurality of paths with only one of the paths being available at a time so that the current can only physically travel down one of the paths. Some embodiments may use a mixture of these two techniques where some paths are available and some are not.

In some examples, the power grid is comprises a plurality of wires interconnected by switches; and the at least one active path is selected by changing a state of at least some of the switches. The switches need not be mechanical switches but could instead be achieved using transistors. Transistors may also be used to limit the current flowing between a drain and a source. For instance, Vgs influences the maximal current flowing between the drain and source. The switches may therefore not merely switch on/off but could work to gradually shift current away from a given path.

In any event, the variance of the path can be achieved by changing some (or all) of the switches so as to vary the path(s) taken by the current from the power source to the component.

In some examples, at least some of the switches have the states: on and off. When the switch has these states, it can either allow conduction (thereby passing the current) or it prevents conduction by providing an open circuit so that the current does not pass. This can be used to enable (when conducting) or disable (when not conducting) some of the paths.

In some examples, at least some of the switches have a states of: connect to a first wire and connect to a second wire. In these examples, the switches conduct current in both states. In one state, current is passed to one wire whereas in another state, current is passed to a second wire. This will enable one set of paths in one state and enable a different set of paths in the second state. Of course, this does not preclude a switch having third or even fourth states so as to enable conduction through third wires and fourth wires, respectively. Furthermore some embodiments allow a mixture of states so that the switch may have a state of “off” (conducting no current), connection to a first wire, and a third state connecting to a second wire. This therefore allows the selection of no paths, one set of paths, or a second set of paths. Similarly, fourth and fifth states could be added thereby allowing third sets of paths and fourth sets of paths.

Of course, of all of these switch configurations, it is appreciated that each switch might have different configurations. Some switches may be on/off, while others might be wire A/wire B, and some switches might be altogether different, containing other states.

In some examples, the circuit component is connected to the power source by a fail-safe path that lacks any of the switches. The fail-safe path can be provided to ensure that, no matter which path or paths are made available there is always a path that can provide power to the component. This can significantly reduce the complexity of the switching logic by not needing to determine that the state of the switches allows the passing of current from the power source to the component and without having to calculate the state of the switches that is necessary to achieve the passing of current from the power source to the component. Instead, the fail-safe path is available because it cannot be switched off entirely. In other embodiments, the fail-safe path has a single switch that allows it to be activated in a fail-safe mode. For instance, if the component does not receive power after some time then it may be concluded that the current state of the switches does not allow the passing of power to the component and the fail-safe mode can be activated in order to allow current to pass to the component once more. Next time the active path(s) is/are selected, the fail-safe mode can be deactivated again.

In some examples, the fail-safe path has a higher resistance than the redundant paths. If such a fail-safe path were present and was the most energetically efficient path for current to pass through then the selection and varying of available paths might have little effect. Consequently, the fail-safe path can be made to be higher resistance than other paths so that the other paths (if available) will be used in preference to the fail-safe path.

In some examples, the at least one active path is selected by setting each of the switches to a random state. Each of the switches could have their state set independently of the others so that paths are created randomly without being known in advance.

In some examples, the at least one active path is selected by changing the state of the switches until the circuit component is powered. For example, all of the switches could start as being non-conducting. A switch could then be randomly selected and set to conducting (i.e. closed). This process could be repeated until the component receives power, at which point the process can stop. In other embodiments, the process might continue for a number of iterations to add further variance to the path that is selected.

In some examples, the function is an arithmetic, combinatorial, or cryptographic function. Such functions are used in cryptography where it is desirable to keep the data used (e.g., keys) private.

In some examples, the apparatus comprises: a plurality of power sources configured to provide power, including the power source; and the plurality of redundant paths enable power to flow from one of the power sources to the circuit component to perform the function. In these examples, there are a plurality of power sources (e.g., battery, mains power, capacitors, and so on). At least one of the power sources has multiple paths to the component. However, further paths may exist by connecting another power source to the component. This adds an increased variety of path lengths.

Particular embodiments will now be described with reference to the figures.

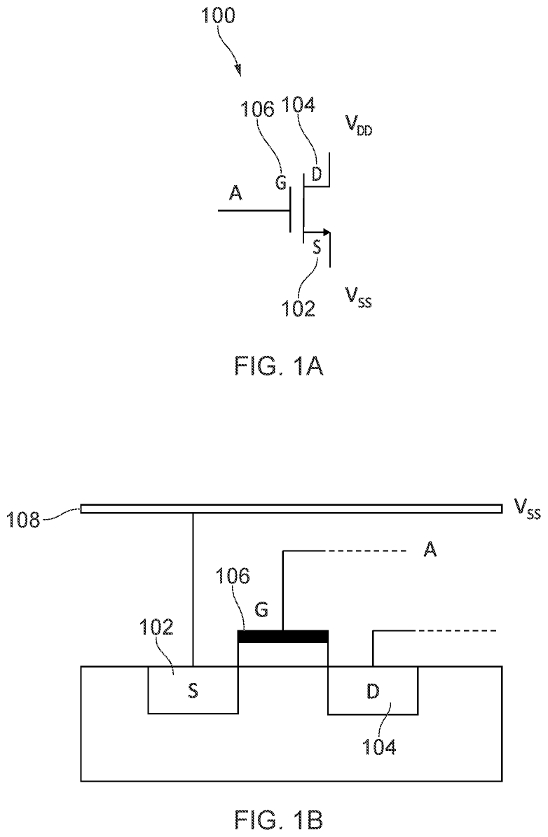

FIG. 1A illustrates an example circuit diagram showing a transistor in the form of an n-type transistor 100. In this example (an n-type MOSFET), a current flows from the drain terminal 104 to the source terminal 102 when a high voltage (compared to the source) is applied to the gate terminal 106. Here, V_{SS} is applied to the source terminal 102, and a variable switching value A is applied to the gate 106. Hence, when A is low no current flows and when A is high, VSS is connected to the drain terminal 104 and to whatever other components are connected to the drain terminal 104.

FIG. 1B shows how such a transistor might be implemented in a circuit on a chip (which is an example of the claimed apparatus). A power grid layer 108 can be provided to connect V_{SS} to any components that require it. A further power grid layer (not shown in this example) can also be provided to connect the components 100 to V_{DD}.

The present technique aims to vary the path taken by the current—either from V_{DD} to the circuit components 100, or from the circuit components 100 to V_{SS}. In either case, since the path is varied, the location (and strength) of electromagnetic fields created as a consequence of current passing through the wires is varied and it becomes more difficult to make inferences about data that passes through the circuitry. In addition, impedance is varied and it again becomes more difficult to infer data values by probing of the impedance. Furthermore, it becomes possible to randomize glitches, which occur due to non-instantaneous value changes. These glitches produce changes in the electromagnetic field (and other characteristics) produced by the circuitry and can be probed. Over a period of time, it may be possible to infer particular values by examination of the glitches.

Consider the example (A XOR B) AND C, which may be implemented using a number of logic gates using transistors. Initially, all of the values are 0 and in one clock cycle they all transition to 1. The result at the end of the clock cycle before the transition and the end of the clock cycle after the transition is 0. However, depending on the order at which the transitions happen, there may or may not be a glitch. If the signals transition in order C, A, B then when C changes, the result will still be 0 because (0 XOR 0) AND 1 is 0. Then when A changes, the result will be 1 because (0 XOR 1) AND 1 is 1. Then when B changes, the result will return to 0 because (1 XOR 1) AND 1 is 0. There is therefore a glitch as the value fluctuates within the clock cycle. This glitch can be monitored by an attacker and over time, it may be possible to probabilistically determine A, B, and/or C. However, if the signals appear in the order A, B, C then when A changes the result will still be 0 because (1 XOR 0) AND 0 is 0. Then when B changes, the result will still be 0 because (1 XOR 1) AND 0 is 0. Then finally when C changes, the result is still 0 because (1 XOR 1) AND 1 is 0. Thus, in this instance, there is no glitch-the output always remains at 0.

The present technique aims to vary the arrival time of signals by varying voltages provided to electrical components, which will cause them to operate at variable speeds. For instance, in the case of FIG. 1B, a change of voltage that powers the gates changes the propagation time through the gates. This in turn is achieved by varying the path(s) taken from power sources to electrical components, which will change the resistance encountered. Consequently, glitches will become more random and this makes it hard for an observer to infer the values being transmitted. For instance in the former timing case in the above paragraph, one might come to associate a glitch with a change in A, B, and/or C. Consequently, if the signals actually arrive in the order A, B, C (as opposed to C, B, A) so that no glitch occurs, one might conclude that none of A, B, and C have changed even though they have all transitioned.

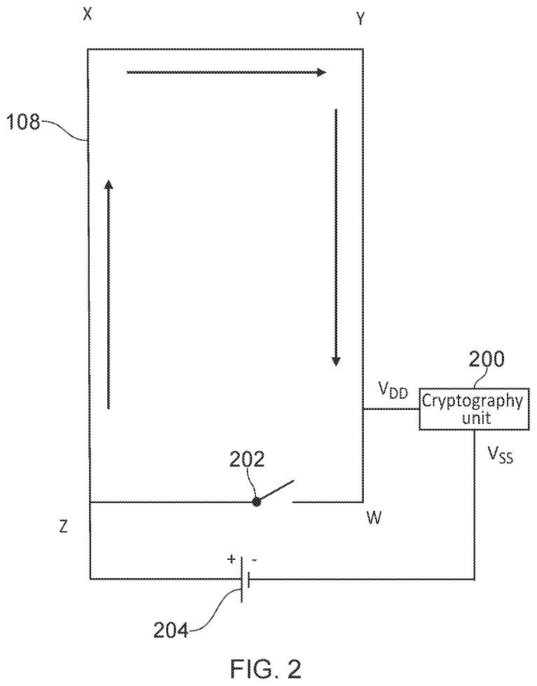

FIG. 2 illustrates how the path(s) to a component 200 (in this case taking the form of a cryptography unit) from a power source can be changed. In this case, the power grid 108 is a V_{DD} power grid and it takes the form of a simple square WXYZ. The grid 108 is connected to a power source 204. A switch 202 is provided that connects Z to W. As shown in FIG. 2, the switch is open meaning that it does not conduct. Consequently, no current can flow directly from Z to W. In this case, there is a single active path that travels from Z to X to Y to the cryptography unit 200, which is also connected to V_{SS} (e.g., ground) in order to provide a complete circuit. If switch 202 is activated, then it will conduct thereby providing two active paths—the existing path ZXY and a new shorter path ZW. These two paths operate in parallel thereby decreasing the overall resistance and so increasing the voltage at the cryptography unit 200. The cryptography unit 200 can therefore propagate signals more quickly than before the switch 202 was activated. In addition, electromagnetic fields are created along the path ZW, the electromagnetic field created along ZXY may be weakened and the impedance of the circuit is changed. All of these changes make it more difficult to infer the behavior of the cryptography unit 200.

In some examples, the switch 202 is a transistor. Also in this example the device being protected by the variable paths is a cryptographic unit. However, in other examples this could be a logic or combinatorial unit (e.g., as might be used in or by a cryptographic unit). The present technique has particular applicability to any unit or circuit in which confidential or secret information is to be kept or used.

Also, although the example of FIG. 2 shows the variance of paths provided for VDD, the same technique is applicable for a V_{SS} power grid. A more complete obfuscation can be achieved by providing the same technique for both V_{SS} and V_{DD} power grids.

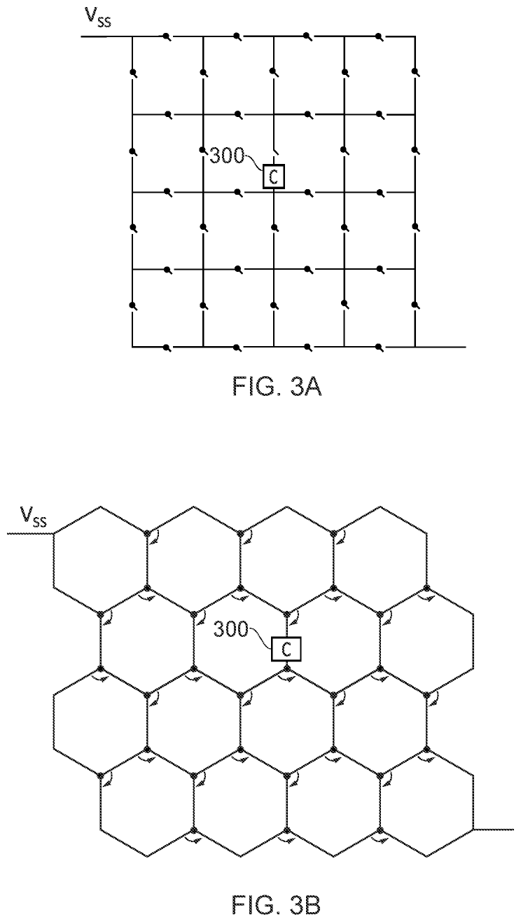

FIG. 3A shows another example in which a single power source V_{DD} and a single ground source V_{SS} are connected to an electrical component 300 using a grid arrangement. The grid is interconnected by switches. In this example, each switch has on/off states. When the switch is set “on” it conducts, thereby enabling a particular path at the interconnection. When the switch is set “off” is does not conduct, thereby disabling the particular path at the interconnection. By setting each switch on or off, one or more active paths can be generated between the power source, the electrical component (and the ground).

Based on the length and number of the active paths, the resistance encountered by current flowing from the power source to the component 300 (and to the ground) will vary and so the voltage will also vary. As explained above, this in turn causes the timing of the electrical component 300 to vary each time the switches are changed.

FIG. 3B illustrates a variant in which the switches are still dual state, but in which the switch is connected to a first wire and the states are for the switch to also be connected to a second wire or also to be connected to a third wire. That is, there is no state in which the switches are not connected to something—although clearly a switch may still fail to conduct if there is not a complete path between itself, V_{SS} and V_{DD}. Once again, by varying the state of each of the switches it is possible to create one or more active paths from the power source to the component 300 and from the component to the ground.

In each of these examples, it is assumed that the switches have two states. However, this is not a limitation of the present technique. In some examples, the switches may have three states. For instance—“off”, “connected to a second wire”, and “connected to a third wire” or alternatively “connected to a second wire”, “connected to a third wire”, and “connected to a fourth wire”. Indeed, switches could have even more states than these.

Also as previously expressed, switches need not be binary. For instance, the value of Vgs can be adjusted at a transistor in order to influence the maximal current flowing between the drain and source. This makes it possible to gradually shift current away from a given path, which again can be used to control the current flow and obfuscate the operation of the circuit.

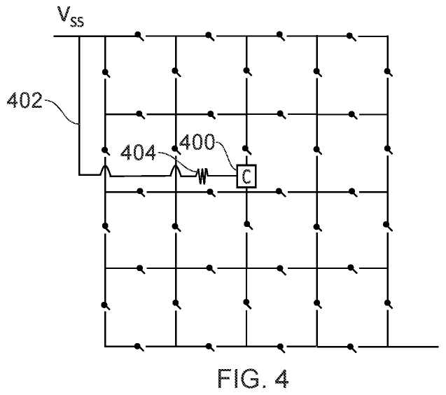

FIG. 4 shows an example in which a fail-safe path 402 has been added to the electrical component 400. The fail-safe path 402 is a static path that, in this example, contains no switches. Consequently, regardless of the settings applied to the switches that are used to create one or more random active paths for current to flow from V_{SS} to the component 400, there will always be at least one active path through which current can flow. In some examples, a further fail-safe path can be added to connect the electrical component 400 to V_{DD}. In this example, a resistor 404 is added, which makes the fail-safe path 402 high resistance. This has the effect that the active paths that are generated through setting of the switches have a significant impact on the timing changes of power delivery. Without this extra resistance, the fail-safe path 402 might always be such a low resistance path that the addition of other active paths might have little to no effect. In such a situation, the creation of active paths (or changing of active paths) will have little overall effect.

In some examples, the fail-safe path might have its own independent fail-safe switch that is activated if, after setting the remaining switches, the component 400 finds itself without power.

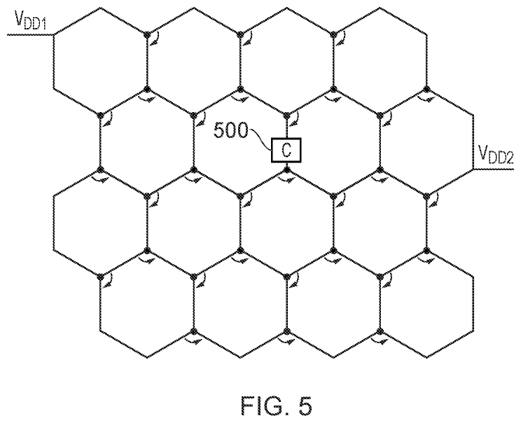

FIG. 5 shows an example in which there are multiple power sources—V_{DD1}, V_{DD2}. These power sources could take the form of other power supplies, voltage rails, batteries, capacitors and so on. Due to the addition of other power sources, the number of possible active paths that can exist are increased. This therefore decreases the probability that the component 500 will be unpowered and also allows for a greater variance of paths. A further consequence of adding the power supply is that in many cases, it will require fewer switches to change to an “on” state to create a path in which the component 500 is powered. This can result in a faster power grid setup.

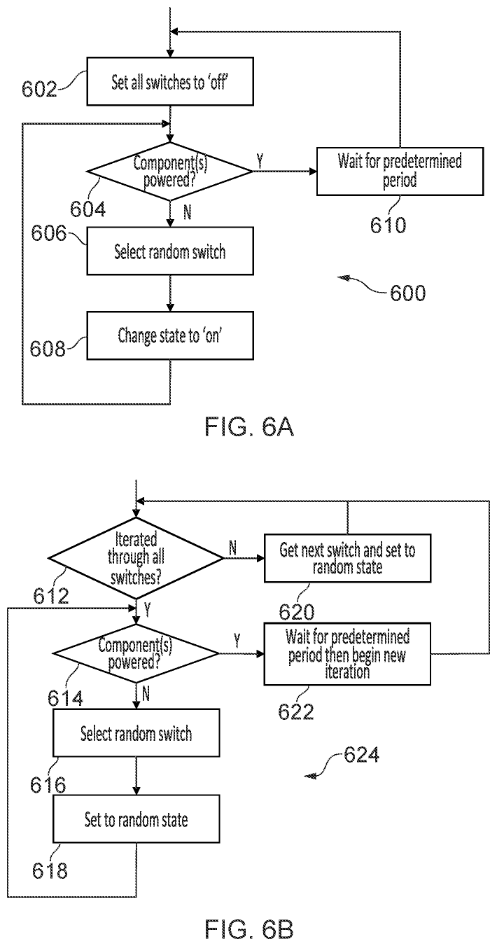

FIG. 6A shows, in the form of a flowchart 600, a first method for configuring the power grid. At a step 602, all the switches are set to “off” or where the switches are connected to one of two wires, to a first wire. Then, at step 604, it is determined whether the component or components is/are powered (that is, all components whose power usage is to be obfuscated). If so, then there is no further configuration to be done and at step 610 a predetermined period elapses before the process starts again (the power grid is reconfigured). This could be a number of seconds (or fractions of a second) or a number of processor cycles. If the component is not powered at step 604 then at step 606 a random switch is selected. Then, at step 608, the state of that switch is changed (to its alternative state or to a random alternative state where more than two states exist). The process then returns to step 604 to determine whether the component is now powered. In effect, this process activates switches until the component is powered.

In some examples, after the component is powered, a number of further switches will be switched to “on” to increase the probability of a plurality of active paths being created.

FIG. 6B shows, in the form of another flowchart 624, another method for selecting an active path. At a step 612, it is determined whether the current iterative process has iterated through all switches. If so, at step 614, it is determined whether the component(s) is/are powered (that is, all components whose power usage is to be obfuscated). If so, then step 622 waits for the predetermined period (as previously explained) and a new iterative process begins at step 612. If the component is not powered, at step 614 then step 616 selects a random switch and switches that switch to a random state at steep 618. The process then returns to step 614. In effect, this process randomly sets the state of all the switches and then starts randomly adjusting switches (one at a time) until the device is powered.

In some examples, the setting of the random state will always select a “connected” state. In either of the above examples, the process may begin at startup, but could also be started in response to an event—e.g., activation of a “secure mode” on a data processing apparatus.

It will be appreciated that these examples show additional features independently of one another and so can be combined. For example, although FIG. 4 illustrates the fail-safe path 402 on a “grid” construction of on/off switches shown in FIG. 2A it can also be applied to the hexagonal construction of wire 1/wire 2 switches shown in FIG. 2B. Similarly, the additional power sources shown in FIG. 5 can be applied to any of these examples. The examples here may relate to only a single component, or may apply to examples with multiple circuit components. In such examples, steps 604 and 614 of FIGS. 6A and 6B respectively determine whether all the components are powered.

Concepts described herein may be embodied in a system comprising at least one packaged chip. The circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

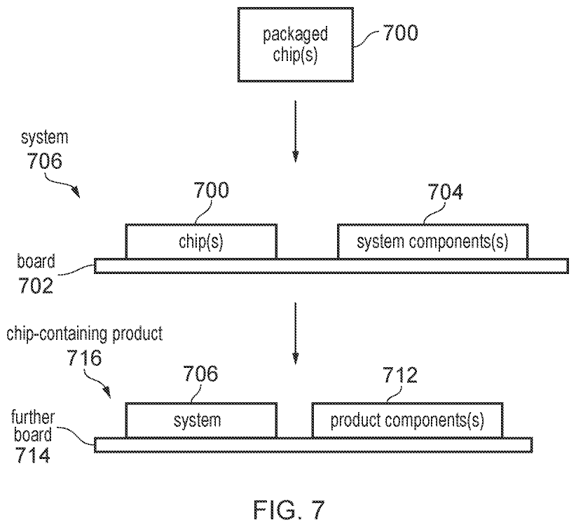

As shown in FIG. 7, one or more packaged chips 700, with the circuitry described above implemented on one chip or distributed over two or more of the chips, are manufactured by a semiconductor chip manufacturer. In some examples, the chip product 700 made by the semiconductor chip manufacturer may be provided as a semiconductor package which comprises a protective casing (e.g., made of metal, plastic, glass or ceramic) containing the semiconductor devices implementing the circuitry described above and connectors, such as lands, balls or pins, for connecting the semiconductor devices to an external environment. Where more than one chip 700 is provided, these could be provided as separate integrated circuits (provided as separate packages), or could be packaged by the semiconductor provider into a multi-chip semiconductor package (e.g., using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g., using an interposer, or by using three-dimensional integration to provide a multi-layer chiplet product comprising two or more vertically stacked integrated circuit layers).

The one or more packaged chips 700 are assembled on a board 702 together with at least one system component 704 to provide a system 706. For example, the board may comprise a printed circuit board. The board substrate may be made of any of a variety of materials, e.g., plastic, glass, ceramic, or a flexible substrate material such as paper, plastic or textile material. The at least one system component 704 comprise one or more external components which are not part of the one or more packaged chip(s) 700. For example, the at least one system component 704 could include, for example, any one or more of the following: another packaged chip (e.g., provided by a different manufacturer or produced on a different process node), an interface module, a resistor, a capacitor, an inductor, a transformer, a diode, a transistor and/or a sensor.

A chip-containing product 716 is manufactured comprising the system 706 (including the board 702, the one or more chips 700 and the at least one system component 704) and one or more product components 712. The product components 712 comprise one or more further components which are not part of the system 706. As a non-exhaustive list of examples, the one or more product components 712 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 706 and one or more product components 712 may be assembled on to a further board 714.

The board 702 or the further board 714 may be provided on or within a device housing or other structural support (e.g., a frame or blade) to provide a product which can be handled by a user and/or is intended for operational use by a person or company.

The system 706 or the chip-containing product 716 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g., a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modeling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modeling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
a circuit component configured to consume power to perform a function; and
a power grid configured to provide a plurality of redundant paths by which the power can flow between the circuit component and one of a power source and ground, to perform the function, wherein
the power grid is configured to dynamically select at least one active path of the redundant paths through which the power flows between the circuit component and the one of the power source and ground, to perform the function.

2. The apparatus according to claim 1, wherein
the power grid is configured to dynamically select the at least one active path at runtime.

3. The apparatus according to claim 1, wherein
the power grid is configured to dynamically select the at least one active path with a predetermined frequency.

4. The apparatus according to claim 1, wherein
the power grid is configured to provide the plurality of redundant paths simultaneously.

5. The apparatus according to claim 1, wherein
the power grid is comprises a plurality of wires interconnected by switches; and
the at least one active path is selected by changing a state of at least some of the switches.

6. The apparatus according to claim 5, wherein
at least some of the switches have the states: on and off.

7. The apparatus according to claim 5, wherein
at least some of the switches have a states of: connect to a first wire and connect to a second wire.

8. The apparatus according to claim 5, wherein
the circuit component is connected to the power source by a fail-safe path that lacks any of the switches.

9. The apparatus according to claim 8, wherein
the fail-safe path has a higher resistance than the redundant paths.

10. The apparatus according to claim 5 wherein
the at least one active path is selected by setting each of the switches to a random state.

11. The apparatus according to claim 5, wherein
the at least one active path is selected by changing the state of the switches until the circuit component is powered.

12. The apparatus according to claim 1, wherein
the function is an arithmetic, combinatorial, or cryptographic function.

13. The apparatus according to claim 1, comprising:
a plurality of power sources configured to provide power, including the power source; and
the plurality of redundant paths enable power to flow from one of the power sources to the circuit component to perform the function.

14. A method, comprising:
consuming power at a circuit component to perform a function;
providing a power grid configured to provide a plurality of redundant paths by which the power can flow between the circuit component and one of a power source and ground, to perform the function, wherein
the power grid is configured to dynamically select at least one active path of the redundant paths through which the power flows between the circuit component and the one of the power source and ground, to perform the function.

15. A non-transitory computer-readable medium to store computer-readable code for fabrication of an apparatus comprising:
a circuit component configured to consume power to perform a function; and
a power grid configured to provide a plurality of redundant paths by which the power can flow between the circuit component and one of a power source and ground, to perform the function, wherein
the power grid is configured to dynamically select at least one active path of the redundant paths through which the power flows between the circuit component and the one of the power source and ground, to perform the function.

16. A system comprising:
the apparatus of claim 1;
at least one system component; and
a board,
wherein the apparatus and the at least one system component are assembled on the board.

17. A chip-containing product comprising the system of claim 16 assembled on a further board with at least one other product component.
